(19) United States
(12) Patent Application Publication
(10) Pub. No.: US 2005/0234729 A1
(43) Pub. Date: Oct. 20, 2005

(54) Mobile unit and method of controlling a mobile unit

(75) Inventor: Holger Scholl, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: Koninkliijke Phillips Electronic N.V.

(21) Appl. No.: 10/516,152

(22) PCT Filed: Jun. 3, 2003
(86) PCT No.: PCT/IB03/02085

§ 371 Date: Nov. 30, 2004

(30) Foreign Application Priority Data
Jun. 5, 2002 (DE) 102 24 816.8

(51) Int. Cl. G10L 11/00

(52) U.S. Cl. 704/275

(57) ABSTRACT

A mobile unit, such as a robot (12) for example, and a method of controlling a mobile unit are presented. The mobile unit has means of locomotion and is capable of acquiring and recognizing speech signals. If, for example due to its distance from a user (24) or due to sources of acoustic interference (20, 22), the position of the mobile unit (12) is of suitable to ensure that spoken commands from the user (24) will be transmitted or recognized to an adequate standard of quality, then at least one destination location (28) is determined at which it is likely that the quality of transmission or recognition will be better. The mobile unit (12 is then moved to a destination position (28). The mobile unit (12) may determine the prospective quality of transmission for speech signals from a user constantly in this case. Similarly, the quality of recognition may be determined only after a speech signal has been received and recognized. If the quality of recognition or prospective quality of transmission is below a preset threshold, then destination positions (28) are determined for the movement of the mobile unit (12) In one embodiment however, the movement of the mobile unit (12) may be abandoned if the burden determined for the movement to the destination location (28) is too high. When this is the case a message is passed to the user (24).

The invention relates to a mobile unit and a method of controlling a mobile unit.

There are robots for a variety of applications that form known mobile units.

What is meant by a “mobile unit” is a unit that has means of its own for locomotion. The unit may for example be a robot that moves around in the home and performs its functions there. It may however equally well be a mobile unit in, for example, a production environment in an industrial enterprise.

The use of voice control for units of this kind is known. A user is able to control the unit with spoken commands in this case. It is also possible for a dialog to be carried on between the user and the mobile unit in which the user asks for various items of information.

Also known are speech recognition techniques. In these, a sequence of words that is recognized is correlated with speech signals. Both speaker-dependent and speaker-independent speech recognition systems are known.

Known speech recognition systems are used for applicational situations in which the position of the speaker is optimized relative to the pick-up system. Known are, for example, dictating systems or the use of speech recognition in telephone systems, in both of which cases the user speaks directly into a microphone provided for the purpose. When on the other hand speech recognition is used in the context of the mobile units, the problem arises that this in itself means that there are a number of disruptions that can occur on the signal path to the point where the acoustic signals are picked up. These include on the one hand sources of acoustic interference, examples being noise sources such as loudspeakers and the noise made by household appliances as they operate. On the other hand however, the distance from the mobile unit to the user and any sound-dampening or sound-reflecting obstacles situated between the two also have an effect. The consequence is that the ability of the mobile unit to understand spoken commands correctly varies widely as a function of the existing situation.

Known from JP-A-09146586 is a speech recognition unit in which a unit is provided to monitor the background noise. By reference to the background noise, it is judged whether the quality of the speech signal is above a minimum threshold. If it is not, the fact of the quality not being good enough is reported to the user. A disadvantage of this solution is that it makes quite high demands on the user.

It is therefore an object of the invention to specify a mobile unit and a method of controlling a mobile unit in which recognition of the speech signals that is as good as possible can be consistently achieved.

This object is achieved by mobile units as detailed in either of claims 1 and 2 and by methods of controlling a mobile unit as detailed in claims 8 and 9. Dependent claims relate to advantageous embodiments of the invention.

The mobile units detailed in claims 1 and 2 and the control methods detailed in claims 8 and 9 in themselves each constitute ways of achieving the object. These ways of achieving the object have certain things in common.

In both cases the mobile unit according to the invention has means of acquiring and recognizing speech signals. The signals are preferably picked up in the form of acoustic signals by a plurality of microphones and are usually processed in digital form. Known speech processing techniques are applied to the signals that are picked up. Known techniques for speech recognition are based on, for example, correlating a hypothesis, i.e. a phoneme for example, with an attribute vector that is extracted by signal processing techniques from the acoustic signal that is picked up. From the prior training, a probability distribution for corresponding attribute vectors is known for each phoneme. In the recognition, various hypotheses, that is to say various phonemes, are rated with a score representing the probability that the attribute vector existing in the given case falls within the known probability distribution for the hypothesis concerned. The provisional outcome of the recognition is then the hypothesis that has the highest score. Also known to the man skilled in the art are further possibilities for improving the recognition such as for example limiting the phoneme chains considered valid by using a lexicon, or giving preference to more probable sequences of words by using a speech model.

According to the first aspect of the invention (claim 1), once a speech signal has been picked up and recognized, it is assessed whether the quality of recognition is sufficiently good. For this purpose, assessment means for assessing the quality of recognition are applied in parallel with the speech recognition means used. Once an acoustic speech sequence has been processed, known speech-recognition algorithms are able to supply, together with the sequence of words recognized, a confidence indicator that provides information on how good the quality of recognition was.

The mobile unit detailed in claim 1 therefore has a control unit that decides whether the quality of recognition obtained is good enough. This can be done by comparing the confidence indicators supplied with a minimum threshold that is preset at a fixed value or can be set to a variable value. Where the control unit concludes that the quality of recognition is not good enough, i.e. is for example below a preset minimum threshold, it determines a destination location for the mobile unit at which the quality of recognition will probably be better. For this purpose, the control unit actuates the means of locomotion of the mobile unit in such a way that the mobile unit moves to the destination location that is determined.

According to the second aspect of the invention, as dealt with in claim 2, the mobile unit likewise has means of locomotion and pick-up and assessment means for speech signals. However, to improve the quality of recognition, in this case the quality of the transmission path for the acoustic speech signals is assessed continuously, i.e. not just at a time when a speech signal has already been emitted and, when there is a need, i.e. when there is a prospect of the quality of transmission not being good enough, the unit is moved accordingly.

For this purpose, the prospective quality with which speech signals from the user will be transmitted to the mobile unit is determined. If the result obtained is not satisfactory, a position at which the quality of recognition is likely to be better is determined for the mobile unit.

The two aspects of the invention that are dealt with in claims 1 and 2 and 8 and 9 respectively, monitoring of the quality of recognition for speech signals currently received on the one hand and continuous monitoring of the quality of transmission on the other, in themselves each achieve the object aimed at and each procedure, separately from one another, an improvement in the recognition of acoustic speech signals by the mobile unit. The two aspects may however also be combined satisfactorily. The embodiments of the invention elucidated below may be used in connection with one or both of the above aspects.

A plurality of destination locations may be determined, in which case the control unit then selects from these a destination location that is suitable and actuates the means of locomotion in such a way that the mobile unit is moved to the location selected. The control unit preferably first determines the burden, measured by reference to a suitable criterion such as the distance to be traveled or the probable journey time, that a movement of this kind would represent. A destination location can then be selected by reference to the burden.

In one embodiment of the invention, the mobile unit does not always move to the destination location. In the event of the burden being above a preset maximum threshold, rather than the unit moving a message is given to the user. In this way the user is able to understand that the mobile unit is unable to accept spoken commands at the moment or that if it did the quality of recognition would be low. The user can react to this by for example selecting a more suitable location or by reducing the effect that a source of interference is having, by turning off a radio for example.

The mobile unit preferably has a number of microphones. With a plurality of microphones it is possible on the one hand for the point of origin of signals that are picked up to be located. The point of origin of a spoken command (i.e. the position of the user) for example can be determined. Similarly, the positions of sources of acoustic interference can be determined. Where there are a plurality of microphones, the desired signal is preferably picked up in such a way that a given directional characteristic is obtained for the group of sensing microphones by beam-forming. This produces a sharp reduction in the effect that sources of interference lying outside the beam area have. On the other hand however, sources of interference situated inside the beam area do have a very severe effect. In determining suitable destinations locations, allowance is therefore made not only for position but also for direction.

The mobile unit preferably has a model of its world. What is meant by this is that information on the three-dimensional environment of the mobile unit is stored in a memory. The information stored may on the one hand be pre-stored. For example, information on the dimensions of a room and on the shapes and positions of the fixed objects situated in it could be deliberately transmitted to a domestic robot. Alternatively or in addition, the information for the world-model could also be acquired by using data from sensors to load and/or to constantly update a memory of this kind. This data from sensors may for example originate from optical sensors (cameras, image recognition facilities) or from acoustic sensors (an array of microphones, signal location facilities).

As part of the mobile unit's world-model, a memory contains information on the positions and, where required, the directions too of sources of acoustic interference, the position and direction of viewing of at least one user and the positions and shapes of physical obstacles. It is also possible for the current position and direction of the mobile unit to be queried. Not all of the information given above has to be stored in every implementation. All that is necessary is that it should be possible for the position and direction of the mobile unit to be determined relative to the position of the user.

The speech recognition means and means of assessing quality of recognition provided in accordance with the invention and the control unit should be understood simply as functional units. It is true that in an actual implementation these units could be in the form of separate subassemblies. It is however preferable for the functional units to be implemented by an electronic circuit having a microprocessor or signal processor in which is run a program that combines all the functionalities mentioned.

These and other aspects of the invention are apparent from and will be elucidated with reference to the embodiments described hereinafter.

In the drawings:

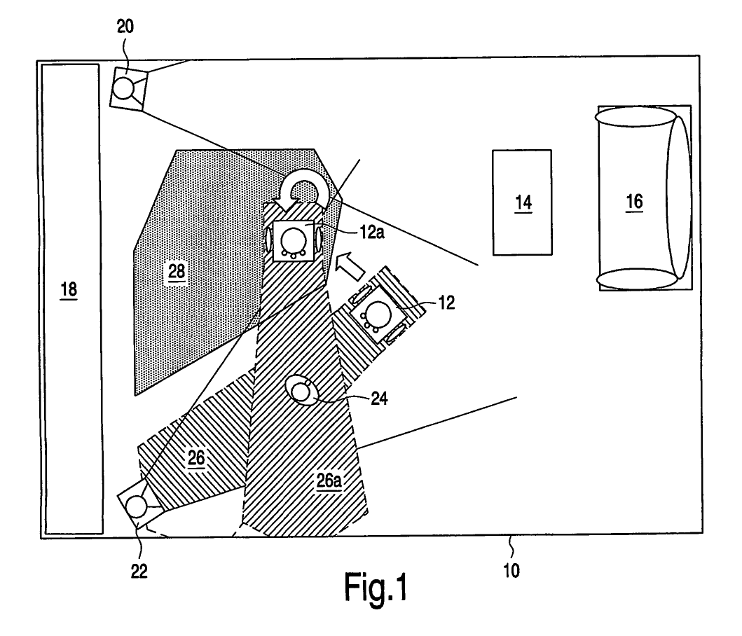

FIG. 1 is a diagrammatic view of a room in which there are a robot and a user.

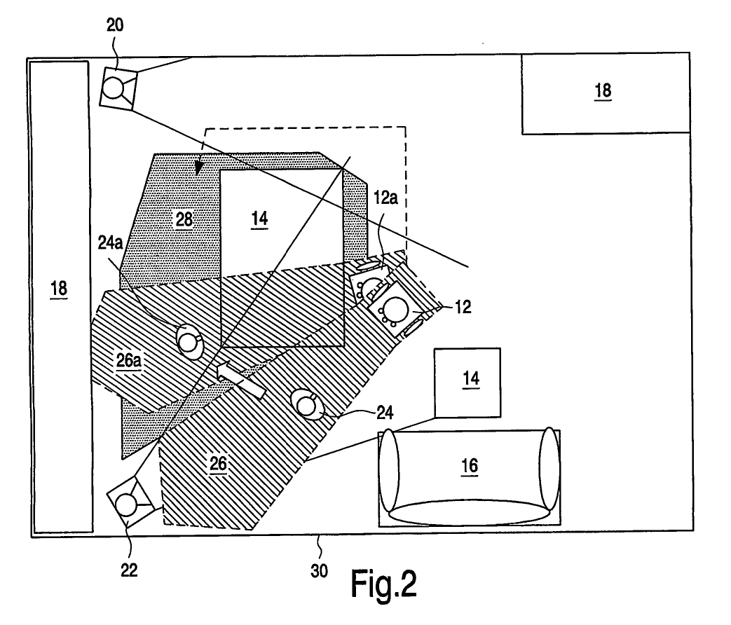

FIG. 2 is a diagrammatic view of a further room in which there are a robot and a user.

FIG. 1 is a diagrammatic plan view of a room 10. Situated in the room 10 is a mobile unit in the form of a robot 12. In the view shown in FIG. 1, the robot 12 is also shown in an alternative position 12a to allow a movement to be explained.

In the room 10 is situated a user 24 who controls the robot 12 with spoken commands.

The room 10 contains a number of physical obstacles for the robot: a table 14, a sofa 16 and a cupboard 18.

Also situated in the room 10 are sources of acoustic interference, in the form of loudspeakers 20, 22 in this case. The loudspeakers 20, 22 reproduce an acoustic signal that superimposes itself on the speech signals from the user 24 and becomes apparent as a disruptive factor on the transmission path from the user 24 to the robot 12. In the present example the loudspeakers 20, 22 have a directional characteristic. The areas in which the interference signals emitted from the enclosures 20, 22 are of an amplitude such that they cause significant interference are indicated diagrammatically in FIG. 1 by lines running from the loudspeakers 20, 22.

The robot 12, which is only diagrammatically indicated, has drive means, which in the present case are in the form of driven, steerable wheels on its underside. The robot 12 also has optical sensing means, in the form of a camera in the present case. The acoustic pick-up means used by the robot 12 are a number of microphones (none of the details of the robot that have been mentioned are shown in the drawings).

The drive means are connected for control purposes to a central control unit of the robot 12. The signals picked up by the microphones and the camera are also directed to the central control unit. The central control unit is a microcomputer, i.e. an electrical circuit having a microprocessor or signal processor, a data or program memory and input/output interfaces. All the functionalities of the robot 12 that are described here are implemented in the form of a program that is run on the central control unit.

Implemented in the central control unit of the robot 12 is a world-model in which the physical environment of the robot 12, as shown in FIG. 1, is mapped. All the objects shown in FIG. 1 are recorded in a memory belonging to the central control unit, each with its shape, direction and position in a co-ordinate system. What are stored are for example the dimensions of the room 10, the location and shape of the obstacles 14, 16 and 18 and the positions of and areas affected by the interference sources 20, 22. The robot 12 is also capable at all times of determining its current position and direction in the room 10. The position and direction of viewing of the user 24 too are constantly updated and entered in the world-model via the optical and acoustic sensing means of the robot 12. The world-model is also continuously updated. If for example an additional physical obstacle is sensed via the optical sensing means or if the acoustic sensing means locate a new source of acoustic interference, then this information is entered in the memory holding the world-model.

One of the functions of the robot 12 is to pick up and process acoustic signals. Acoustic signals are constantly being picked up by the various microphones mounted in known positions on the robot 12. The sources of these acoustic signals—sources of both interference signals and desired signals—are located from the differences in transit time when picked up by different microphones and are entered in the world-model. A match is also made with image data supplied by the camera, to enable sources of interference to be located, recognized and characterized for example.

A desired signal is constantly being picked up via the microphones. To obtain a directional characteristic in this case, use is made of the “beam-forming” technique. This technique is known and will therefore not be elucidated in detail. The outcome is that signals are picked up essentially from the area 26 that is shown hatched in FIG. 1.

A further function of the robot 12 is speech recognition. The desired signal picked up from the area 26 is processed by a speech recognition algorithm to enable an acoustic speech signal contained in it to be correlated with the associated word or sequence of words. Various techniques may be employed for the speech recognition, among them both speaker-dependent and speaker-independent recognition. Techniques of this kind are known to the person skilled in the art and they will therefore not be gone into in any greater detail here.

In speech recognition, it is not only a word or a sequence of words corresponding to the acoustic speech signal that is produced but also, for each word that is recognized, a confidence indicator that states how good a degree of agreement there is between the acoustic speech signal being analyzed and pre-stored master patterns. This confidence indicator thus provides a basis for assessing the probability of the recognition being correct. Examples of confidence indicators are for example the difference in scores between the hypothesis assessed as best and the next best hypothesis, or the difference in scores between it and the average of the N next best hypotheses, with the number N being suitably selected. Other indicators are based on the “stability” of the hypothesis in word graphs (how often a hypothesis occurs in a given recognition area compared with others) or as given by different speech model assessments (if the weights of the speech model weighting scheme are altered slightly, does the best hypothesis then change or does it remain stable?). The purpose of confidence indicators is, by taking a sort of meta-view of the recognition process, to enable something to be said about how definite the process was or whether there were a large number of hypotheses whose ratings were almost the same, thus arousing the suspicion that the result found is of a rather random nature and might be wrong. It is not unusual for a number of individual confidence indicators to be combined to enable an overall decision to be made (this decision usually being made from training data).

In the present case the confidence indicator is for example linear and its value is between 0 and 100%. In the present example it is assumed that the recognition is probably incorrect if the confidence indicator is less than 50%. However, this value is only intended to make the elucidation clear in the present case. In an actual application, the person skilled in the art can define a suitable confidence indicator and can lay down for it a threshold above which he considers that there will be an adequate probability of the recognition being correct.

The way in which the robot 12 operates in recognizing speech signals from the user 24 will now be explained, first by reference to FIG. 1. In this case the robot 12 is oriented at the outset in such a way that the user 24 is within its beam area If the user 24 gives a spoken command, this is picked up by the microphones of the robot 12 and processed. The application of the prescribed speech recognition to the signal gives the probable meaning of the acoustic speech signal.

A correctly recognized speech signal is understood by the robot 12 as a control command and is executed.

However, as shown in FIG. 1, there is a source of interference in the beam area, namely the loudspeaker 22 in this case. The speech signal from the user 24 therefore has an interference signal superimposed on it. Therefore, even though the geometrical layout is favorable in the example shown (the distance between the robot 12 and the user 24 is relatively small and the user 24 and robot 12 are facing towards one another), the speech recognition will not be satisfactory in this case and this will be evident from too low a confidence indicator.

This being the case, the central control unit of the robot 12 decides that the quality of recognition is not good enough. Use is then made of the information present in the memory (world-model) of the central control unit to calculate an alternative location for the unit 12 at which the quality of recognition will probably be better. Also stored in the memory are both the position of the loudspeaker 22 and the area affected by it and also the position of the user 24 as determined by locating the speech signal. As well as this, the control unit knows the beam area 26 of the robot 12.

From this information, the central control unit of the robot 12 determines a set of locations at which the quality of recognition will probably be better. Locations of this kind can be determined on the basis of geometrical factors. What may be determined in this case are all the positions and associated directions of the robot 12 in the room 10 at which the user 24 is within the beam area 26 but there is no source of interference 20, 22 in the beam area 26. Other criteria may also be applied such as, for example, that the angle between the centerline of the beam and the direction of viewing of the user 24 must not be more than 90°. Other information too from the world-model may be used to determine suitable destination positions, and an additional requirement that may be laid down in this way may for example be that there must not be a physical obstacle 14, 16, 18 between the robot 12 and the user 24. There may also be a minimum and/or maximum distance defined between the user 24 and the robot 12 outside which experience shows that there will be a severe drop in the quality of recognition. The person skilled in the art will be able to determine the criteria to be selected in any specific application on the basis of the above considerations.

In the present example, an area 28 of destination positions is formed that is shown hatched. Assuming the robot 12 is aligned in a suitable direction, namely facing towards the user 24, the effect of the source of interference 22 is considerably smaller in this area.

Of the destination positions determined within the destination area 28, the central control unit of the robot 12 selects one. There are various criteria that may be applied to allow this position to be selected. A numerical burden indicator may be determined for example. This burden indicator may for example represent the time that will probably be needed for the robot 12 to move to a given position and for it then to turn. There are other burden indicators that are also conceivable.

In the example shown in FIG. 1, the destination position that the central control unit selected within the area 28 is the one in which the robot is shown for a second time as 12a Because none of the physical obstacles 14, 16, 18 obstruct the movement of the robot 12 to this position in the present case, the central control unit can actuate the means of locomotion is such a way that the displacement and rotation of the robot 12 that are indicated by arrows in FIG. 1 can take place.

In the destination position, the robot 12a is lined up on the user 24. There is no source of interference within the beam area 26a. Spoken commands from the user 24 can be picked up by the robot 12a without any superimposed interference signals and can therefore be recognized with a high degree of certainty. This fact is expressed by high confidence indicators.

A scene in a second room 30 is shown in FIG. 2, using the same diagrammatic conventions as in FIG. 1. In this case too, physical obstacles (sofa 16, tables 14, cupboards 18) and sources of interference 20, 22 are present in the room 30. The starting positions of the robot 12 and the user 24 are the same as in FIG. 1. Because of the interference source 22 located in the beam area 26, the quality of recognition of the spoken commands uttered by the user 24 is so low as to be below the preset threshold for the confidence indicator (50%).

As in the case of the scene shown in FIG. 1, the central control unit of the robot 12 determines the area 28 as the set of locations at which the robot 12 can be so positioned that the beam area 26 will cover the user 24 without there also being a source of interference 20, 22 in the beam area 26.

However, in the scene shown in FIG. 2 part of the area 28 is blocked by a physical obstacle (the table 14). The position and dimensions of the physical obstacles are stored in the world-model of the robot 12, either as a result of a specific input of data or as a result of the obstacles being sensed by sensors (e.g. a camera and possibly contact sensors) belonging to the robot 12 itself.

After the step of determining the destination area 28, the central control unit then determines which of the destination points the robot 12 is to home in on. However, because of the known physical obstacle 14, there is a barrier to direct access to the area 28. The central control unit of the robot 12 recognizes that a diversion (the broken-line arrow) will have to be made round the obstacle 14 to reach a position within the area 28 to which access is free.

As has already been explained in connection with FIG. 1, a burden indicator is determined in this case, by reference to the distance that will have to be covered for example. In situation no.2 this distance is relatively large (the broken-line arrow). If the burden indicator exceeds a maximum threshold (e.g. distance to be traveled more than 3 m), the central control unit of the robot 12 decides that rather than the (burdensome) movement of the robot 12 a message will be passed to the user 24. This may be done in the form of an acoustic or visual signal. In this way the robot 12 signals to the user 24 that he should move to a position in which the quality of recognition will probably be better. In the present case, what this means is that the user 24 moves to a position 24a The robot 12 turns at the same time, as indicated diagrammatically at 12a, so that the user 24a will be in the beam area 26a. Here, spoken commands from the user 24a can then be received, processed and recognized to an adequate standard of quality.

In connection with FIGS. 1 and 2, the behavior of the robot 12 has so far been presented as a reaction to spoken commands received. However, as well as this, the robot 12 will also move even when in its standby state, i.e. a state in which it is ready to receive spoken commands, to ensure that when spoken commands of this kind are received from the user 24 they are received in the best possible way.

On the basis of its world-model, which gives information on its own position and direction (and thus on the location of the beam area 26), on the position and direction of the user 24 and on the location of the sources of interference 20, 22, the central control unit of the robot 12 is able to calculate the prospective quality of transmission even before spoken commands are received. Factors that may influence the quality of transmission are in particular the distance between the robot 12 and the user 24, the position of sound-dampening obstacles (e.g. the sofa 16) between the user 24 and the robot 12, the effect of sources of interference 20, 22 and the direction in which the robot 12 on the one hand is looking (the beam area 26) and that in which the user 24 on the other is looking. However, even from only a relatively coarse world-model for the robot in which only some of the factors mentioned above are allowed for, problems that can be anticipated beforehand in the transmission and recognition of spoken commands can be predicted. The points considered in this case are the same as those mentioned above that are considered when determining a location at which the quality of transmission will probably be good enough. Hence the same program module within the operating program of the central control unit of the robot 12 can be used both for determining possible destination locations and for predicting the transmission quality that can be expected. Apart from purely geometrical considerations (position is to be selected in such a way that beam area is free of sources of interference and user is in beam area), key parameters can be calculated to determine suitable destination positions. Key parameters that can be used to assess the prospective quality of transmission are for example estimates of SNR (possible with the help of a test signal specially radiated by the robot) or direct measurements of noise.

This too can be elucidated by way of illustration with reference to FIG. 1. If the robot is in the position shown in FIG. 1 relative to the user 24, the central control unit of the robot 12 can recognize even without receiving a spoken command that the quality of transmission from the user 24 to the robot 12 will probably not be good enough for the proper recognition of a spoken command. In this case the central control unit of the robot 12 recognizes that although the person 24 is in the beam area 26, the source of interference 22 is also situated in the beam area 26. As has already been described in connection with FIG. 1, the central control unit therefore determines the destination area 28, selects the more suitable position 12a in it, and moves the robot 12 to this position.

With the robot 12 in the standby state, the central control unit constantly monitors the position of the user 24 and determines the prospective quality of transmission. If in so doing the control unit comes to the conclusion that the prospective quality of transmission is below a minimum threshold (a criterion and a suitable minimum threshold for it can easily be formulated for an actual application by the person skilled in the art), then the robot 12 moves to a more suitable position or turns in a suitable direction.

The invention can be summed up by saying that a mobile unit, such as a robot 12, and a method of controlling a mobile unit, are presented. The mobile unit has means of locomotion and is capable of acquiring and recognizing speech signals. If, due for example to its distance from a user 24 or due to sources of acoustic interference 20, 22, the position of the mobile unit 12 is not suitable to ensure that spoken commands from the user 24 are transmitted or recognized with an adequate standard of quality, then at least one destination location 28 is determined at which the quality of recognition or transmission will probably be better. The mobile unit 12 is then moved to a destination position 28.

The mobile unit 12 may, in this case, determine the prospective quality of transmission for speech signals from a user constantly. Similarly, the quality of recognition may be determined only after a speech signal has been received and recognized. If the quality of recognition or the prospective quality of transmission is below a preset threshold, then destination locations 28 are determined for the movement of the mobile unit 12. In one embodiment however it is possible for the movement of the mobile unit 12 to be abandoned if the burden determined for the movement to the destination position 28 is too high. If this is the case a message is passed to the user 24.

1. A mobile unit (12), having:
means for moving the unit (12);
means for acquiring and recognizing speech signals; and
assessing means for assessing the quality of recognition is good enough, and that, if the quality of recognition is not good enough, determines at least one destination location (28) for the mobile unit (12) at which the quality of recognition will probably be better, in which case the control unit actuates the means of locomotion in such a way that the mobile unit (12) is moved to the destination location (28) determined.

2. A mobile unit, having:
means for moving the unit (12); and
means for acquiring and recognizing speech signals from at least one user (24);
a control unit that decides whether the quality of transmission from the user (24) to the mobile unit (12) will probably be good enough for speech recognition, and that, if the quality of transmission will probably not be good enough, determines at least one destination location (28) for the mobile unit (12) at which the quality of transmission will probably be better, in which case the control unit actuates the means of locomotion in such a way that the mobile unit (12) is moved to the destination location (28) determined.

3. A mobile unit as claimed in claim 1.

4. A mobile unit as claimed in claim 1, in which the control unit:
determines a set (28) comprising a plurality of destination locations;
determines for the destination locations determined the burden that a movement of the unit (12) to the relevant destination location would involve; and
selects a destination location that is favorable with respect to the burden from the set of destination locations (28).

5. A mobile unit as claimed in claim 1, in which the control unit determines the burden that movement of the unit (12) to the destination location (28) determined would involve, and in the event that the burden exceeds a maximum threshold, the means of locomotion are not actuated but a message to the user (24) is generated.

6. A mobile unit as claimed in claim 1, in which means are provided for locating the point of origin of acoustic signals that are picked up.

7. A mobile unit as claimed in claim 1, in which a memory is provided in which information of at least one of the following types is stored:
the position of sources of acoustic interference (20, 22);
the position of the user (24);
the position of the physical obstacles (14, 16, 18);
the position and direction of the mobile unit (12).

8. A method of controlling a mobile unit, in which:
speech signals are picked up; and
speech recognition is carried out on the signals, thus assessing the quality of recognition, and, in the event of the quality of recognition not being good enough, at least one destination location (28) is determined for the mobile unit (12) at which the quality of recognition will probably be better, the mobile unit (12) then moving to the destination location (28).

9. A method of controlling a mobile unit, in which the mobile unit (12) constantly determines the prospective quality of transmission of speech signals from a user (24) to the mobile unit (12), and, in the event of the quality of transmission probably being not good enough, at least one destination location (28) is determined for the mobile unit (12) at which the quality of transmission will probably be better, the mobile unit (12) then moving to the destination location (28).
